(19) United States
(12) Patent Application Publication
(10) Pub. No.: US 2020/0132077 A1
(43) Pub. Date: Apr. 30, 2020

(54) COMPRESSOR

(71) Applicants: HYUNDAI MOTOR COMPANY, Seoul (KR); KIA MOTORS CORPORATION, Seoul (KR)

(72) Inventors: Kyoung Ku Ha, Anyang-si (KR); Chang Ha Lee, Yongin-si (KR)

(73) Assignees: HYUNDAI MOTOR COMPANY, Seoul (KR); KIA MOTORS CORPORATION, Seoul (KR)

(21) Appl. No.: 16/455,305

(22) Filed: Jun. 27, 2019

(30) Foreign Application Priority Data
Oct. 25, 2018 (KR) 10-2018-0128254

(51) Int. Cl. F04D 17/10; F04C 29/04; F04D 29/059; F04D 25/06; F04D 29/28; F16C 17/02

(52) U.S. Cl. CPC F04D 17/10; F04C 29/047; F16C 17/024; F04D 25/06; F04D 29/284; F04D 29/059

(57) ABSTRACT

A compressor includes a shaft extending in axial directions thereof, an impeller secured to one end of the shaft, a first bearing action member provided at the one end of the shaft, a second bearing action member provided at an opposite end of the shaft that is opposite to the one end of the shaft, a first bearing that acts on the first bearing action member and supports the first bearing action member in one axial direction of the axial directions and in a radially inward direction of the shaft, and a second bearing that acts on the second bearing action member and supports the second bearing action member in another axial direction, which is opposite to the one axial direction, and in the radially inward direction of the shaft.

### CROSS-REFERENCE TO RELATED APPLICATION

This application claims the benefit of and priority to Korean Patent Application No. 10-2018-0128254, filed in the Korean Intellectual Property Office on Oct. 25, 2018, the entire contents of which are incorporated herein by reference.

### TECHNICAL FIELD

The present disclosure relates to a compressor.

### BACKGROUND

A fuel cell system may include a compressor for providing compressed air to fuel cells. The air compressor may be used to improve the efficiency of the fuel cells by supplying the compressed air into a cathode of each fuel cell.

A double-stage compressor may be used in the fuel cell system. In the double-stage compressor, a low-pressure compressor wheel (or impeller) may be secured to one end of a shaft. A high-pressure compressor wheel (or impeller) may be secured to an opposite end of the shaft.

The shaft is driven by a motor. The compressor wheels (or impellers) are rotated by the rotation of the shaft. In this way, air at room temperature and atmospheric pressure is introduced to the low-pressure compressor wheel and compressed to a first pressure, after which the compressed air is introduced to the high-pressure compressor wheel and additionally compressed to a second pressure. The compressed air is supplied into the fuel cell to improve reaction of the fuel cell.

The double-stage compressor in the related art requires a plurality of bearings and runners (or collars or thrusts) to rotatably support the shaft having the impellers secured thereto and prevent the shaft from moving in axial directions or a radial direction. For example, the double-stage compressor may include a pair of bearings mounted on the opposite ends of the shaft to support the shaft in the radial direction, runners extending from the shaft in the radial direction, and one or more bearings acting on the runners to support the shaft in the axial directions.

According to the related art, the double-stage compressor must include the runners (or collars or thrusts) and requires a number of bearings. As a result, the double-stage compressor has problems in that it has many components and is manufactured through a complex process.

### SUMMARY

The present disclosure is made to solve the above-mentioned problems occurring in the prior art while advantages achieved by the prior art are maintained intact.

An aspect of the present disclosure provides a compressor with a simplified structure in which one bearing simultaneously bears axial and radial loads of a shaft.

Another aspect of the present disclosure provides a compressor for axially supporting a shaft without a runner, a collar, or a thrust for axially supporting a shaft of a compressor in the related art.

Another aspect of the present disclosure provides a compressor for raising the critical frequency of a shaft thereof by reducing the longitudinal length of the shaft, and for improving the safety of the compressor by additionally ensuring a separation margin between the operation frequency and the critical frequency of the shaft.

The technical problems to be solved by the present disclosure are not limited to the aforementioned problems. Any other technical problems not mentioned herein will be clearly understood from the following description by those having ordinary skill in the art to which the present disclosure pertains.

According to an aspect of the present disclosure, a compressor includes a shaft extending in axial directions thereof, an impeller secured to one end of the shaft, a first bearing action member provided at the one end of the shaft, a second bearing action member provided at an opposite end of the shaft that is opposite to the one end of the shaft, a first bearing that acts on the first bearing action member and supports the first bearing action member in one axial direction of the axial directions and in a radially inward direction of the shaft, and a second bearing that acts on the second bearing action member and supports the second bearing action member in another axial direction, which is opposite to the one axial direction, and in the radially inward direction of the shaft.

According to another aspect of the present disclosure, a compressor includes a shaft extending in axial directions thereof, a first impeller secured to one end of the shaft and including, at one side thereof, first blades for guiding a flow of fluid and, at an opposite side thereof, a first action surface with a tapered shape that becomes narrower toward a distal end, a second impeller secured to an opposite end of the shaft that is opposite to the one end of the shaft to which the first impeller is secured, the second impeller including, at one side thereof, second blades for guiding the flow of the fluid and, at an opposite side thereof, a second action surface with a tapered shape that becomes narrower toward a distal end, and first and second bearings that act on the first and second action surfaces, respectively.

The first and second action surfaces face each other.

The first bearing acts on the first action surface and supports the first impeller in one of the axial directions and in a radially inward direction of the shaft.

The second bearing acts on the second action surface and supports the second impeller in the other axial direction, which is opposite to the one axial direction, and in the radially inward direction of the shaft.

### BRIEF DESCRIPTION OF THE DRAWINGS

The above and other objects, features, and advantages of the present disclosure will be more apparent from the following detailed description taken in conjunction with the accompanying drawings:

FIG. 1 is a schematic view illustrating a compressor according to an embodiment of the present disclosure;

FIG. 2 is a view illustrating a part of the compressor of FIG. 1;

FIG. 3 is a view illustrating a part of a compressor according to another embodiment of the present disclosure; and

FIG. 4 is a view illustrating a part of a compressor according to yet another embodiment of the present disclosure.

### DETAILED DESCRIPTION

Hereinafter, embodiments of the present disclosure are described in detail with reference to the accompanying drawings. It should be understood that even if shown in different drawings, identical components are provided with identical reference numerals in the drawings. Furthermore, in describing the embodiments of the present disclosure, detailed descriptions related to well-known functions or configurations are omitted when they may make subject matters of the present disclosure unnecessarily obscure.

Terms, such as “first”, “second”, “A”, “B”, “(a)”, “(b)”, and the like, may be used herein to describe components of the present disclosure. Such terms are only used to distinguish one component from another component. The substance, sequence, order, or number of these components is not limited by these terms. If a component were described as “connected”, “coupled”, or “linked” to another component, they may mean the components are not only directly “connected”, “coupled”, or “linked” but also are indirectly “connected”, “coupled”, or “linked” via a third component.

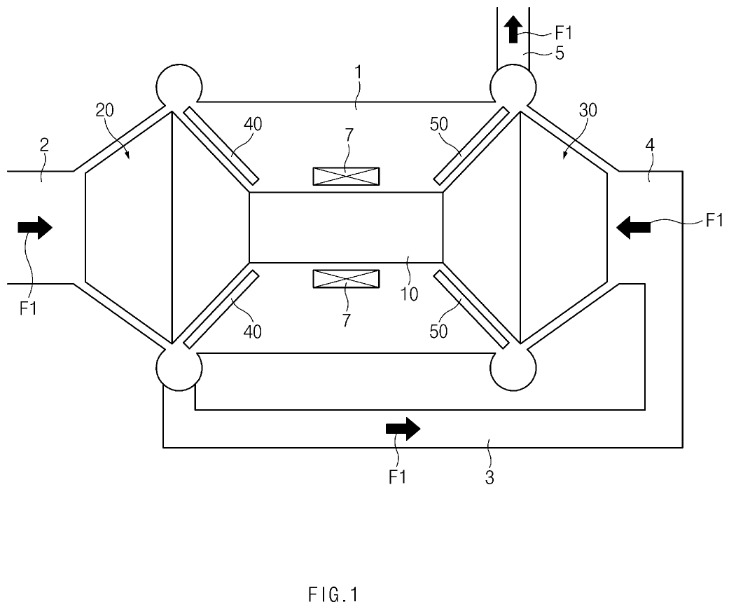

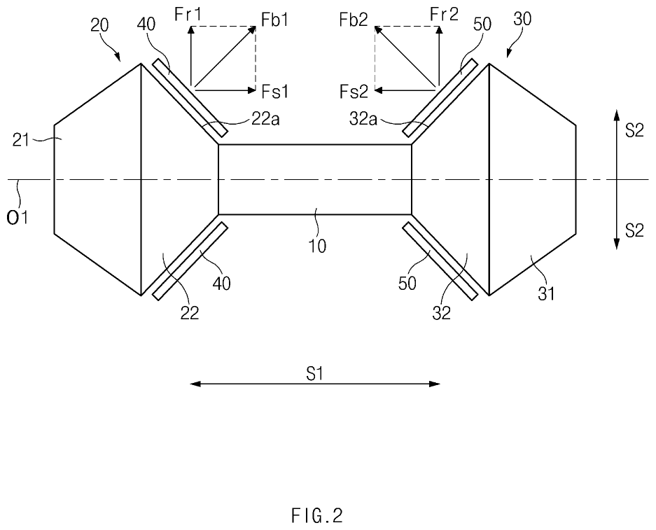

FIG. 1 is a schematic view illustrating a compressor according to an embodiment of the present disclosure. FIG. 2 is a view illustrating a part of the compressor of FIG. 1.

The compressor according to this embodiment includes a housing 1, a shaft 10, a first impeller 20, and a second impeller 30.

The housing 1 may form the appearance of the compressor and may have an inner space in which to accommodate the shaft 10, the first impeller 20, and the second impeller 30.

The housing 1 may include a first impeller-side inlet 2 to guide fluid toward the first impeller 20.

The housing 1 may include a second impeller-side inlet 4 to guide the fluid compressed by the first impeller 20 toward the second impeller 30. The housing 1 may include a connecting duct 3 to guide the fluid released from the first impeller 20 toward the second impeller-side inlet 4.

The housing 1 may include an outlet 5 through which the fluid compressed by the second impeller 30 is released.

The shaft 10 may extend in axial directions S1 and may be mounted in the housing 1 so as to be rotatable about the axis thereof. The shaft 10 may be rotated by a driving force from a motor 7.

The motor 7 may include a rotor (not illustrated) that is mounted on the shaft 10 and that rotates together with the shaft 10 and a stator (not illustrated) that is located in a position corresponding to the rotor to generate a magnetic field with the rotor.

The motor 7 may receive external electric power and may provide a driving force to rotate the shaft 10.

The first impeller 20 may be secured to one end of the shaft 10.

The first impeller 20 may include a first blade part 21 for compressing the fluid, at one side thereof with respect to the axial directions S1 of the shaft 10.

The first impeller 20 may include a first bearing action member 22 at an opposite side thereof, which is opposite to the one side of the first impeller 20 at which the first blade part 21 is located, with respect to the axial directions S1 of the shaft 10.

The first impeller 20 may compress the fluid (e.g., air or hydrogen gas) introduced through the first impeller-side inlet 2 and may release the compressed fluid to the connecting duct 3.

The second impeller 30 may be secured to an opposite end of the shaft 10, which is opposite to the one end of the shaft 10 to which the first impeller 20 is secured.

The second impeller 30 may include a second blade part 31 for compressing the fluid, at one side thereof with respect to the axial directions S1 of the shaft 10.

The second impeller 30 may include a second bearing action member 32 at an opposite side thereof, which is opposite to the one side of the second impeller 30 at which the second blade part 31 is located, with respect to the axial directions S1 of the shaft 10.

The second impeller 30 may compress the fluid (e.g., air or hydrogen gas) introduced through the second impeller-side inlet 4 and may release the compressed fluid to the outlet 5.

Referring to FIG. 1, the flow direction F1 of the fluid in the above-configured compressor is indicated by arrows.

Referring to FIG. 2, a first bearing 40 may act on a first action surface 22a and may support the first bearing action member 22 in one of the axial directions S1 and in a radially inward direction of the shaft 10 (i.e., an opposite direction to a radial direction S2).

A second bearing 50 may act on a second action surface 32a and may support the second bearing action member 32 in the other axial direction S1 and in the radially inward direction of the shaft 10 (e.g., the opposite direction to the radial direction S2).

A double-stage compressor in the related art requires a plurality of bearings and runners (or collars or thrusts) to rotatably support a shaft having impellers secured thereto and prevent the shaft from moving in axial directions or a radial direction. For example, the double-stage compressor may include a pair of bearings mounted on opposite ends of the shaft to support the shaft in the radial direction, runners extending from the shaft in the radial direction, and one or more bearings acting on the runners to support the shaft in the axial directions.

According to the related art, the double-stage compressor must include the runners (or collars or thrusts) and requires a number of bearings. As a result, the double-stage compressor has problems in that it has many components and is manufactured through a complex process.

The present disclosure relates to a compressor with a simplified structure in which one bearing simultaneously bears axial and radial loads of a shaft. More specifically, the compressor according to this embodiment has a feature where the compressor includes the first and second bearing action members 22 and 32 with a tapered action surface and the first and second bearings 40 and 50 acting on the first and second bearing action members 22 and 32, thereby achieving a simplified structure.

Features of the compressor according to this embodiment are described below in more detail.

Referring to FIG. 2, in this embodiment, the shaft 10 is installed to rotate about the center of rotation O1.

The first impeller 20 may include the first blade part 21 and the first bearing action member 22. The first blade part 21 and the first bearing action member 22 may be integrated with each other.

The first blade part 21 may include a plurality of blades and may compress the fluid when the first impeller 20 secured to the shaft 10 rotates.

The first bearing action member 22 may have a rotating body shape with a gradually decreasing diameter from the one end of the shaft 10 to the center thereof and may include the first action surface 22a with a tapered shape on which the first bearing 40 acts.

That is, the first bearing action member 22 may have a frusto-conical shape, which is obtained by cutting a cone with a plane parallel to the base of the cone, and may have a gradually decreasing diameter from one end of the first bearing action member 22 to an opposite end thereof.

The first bearing 40 may be implemented with a tapered bearing and may be mounted in the housing 1 to act on the first action surface 22a. Various types of bearings, such as a tapered roller bearing, an air-foil bearing, and the like, may be applied to the first bearing 40.

The force Fb1 exerted on the first bearing 40 by the first bearing action member 22 may be represented as in FIG. 2. The force Fb1 exerted on the first bearing 40 may be resolved into the component force Fs1 facing the other axial direction S1 of the shaft 10 and the component force Fr1 facing the radial direction S2 of the shaft 10.

The second impeller 30 may include the second blade part 31 and the second bearing action member 32. The second blade part 31 and the second bearing action member 32 may be integrated with each other.

The second blade part 31 may include a plurality of blades and may compress the fluid when the second impeller 30 secured to the shaft 10 rotates. The second blade part 31 may compress the fluid, which is introduced to the second impeller 30 after compressed once by the first impeller 20, to a higher pressure.

The second bearing action member 32 may have a rotating body shape with a gradually decreasing diameter from the opposite end of the shaft 10 to the center thereof and may include the second action surface 32a with a tapered shape on which the second bearing 50 acts.

That is, the second bearing action member 32 may have a frusto-conical shape, which is obtained by cutting a cone with a plane parallel to the base of the cone, and may have a gradually decreasing diameter from one end of the second bearing action member 32 to an opposite end thereof.

The second bearing 50 may be implemented with a tapered bearing and may be mounted in the housing 1 to act on the second action surface 32a. Various types of bearings, such as a tapered roller bearing, an air-foil bearing, and the like, may be applied to the second bearing 50.

The second bearing 50 may be advantageously implemented with a bearing of the same type as the bearing applied to the first bearing 40 in terms of even distribution of loads acting on the shaft 10 and the impellers 20 and 30. However, without being limited thereto, the first and second bearings 40 and 50 may be implemented with different types of bearings.

The force Fb2 exerted on the second bearing 50 by the second bearing action member 32 may be represented as in FIG. 2. The force Fb2 exerted on the second bearing 50 may be resolved into the component force Fs2 facing the one axial direction S1 of the shaft 10 and the component force Fr2 facing the radial direction S2 of the shaft 10.

Although FIG. 2 illustrates a view from a side, the first and second bearings 40 and 50 may surround the first and second action surfaces 22a and 32a in the direction of rotation of the shaft 10, respectively.

Accordingly, the radial component forces Fr1 and Fr2 may cancel each other out. The shaft 10 may be prevented from moving in the radial direction S2. That is, the shaft 10 may be supported in the radially inward direction (i.e., the opposite direction to the radial direction S2) by the radial component forces Fr1 and Fr2.

Furthermore, the axial component force Fs1 acting on the first bearing 40 and the axial component force Fs2 acting on the second bearing 50 may cancel each other out. Therefore, the shaft 10 may be prevented from moving in the axial directions S1. That is, the shaft 10 may be supported in the axial directions S1 by the axial component forces Fs1 and Fs2.

In an embodiment, the first and second bearing action members 22 and 32 may be formed such that the action surfaces 22a and 32a have the same inclination angle. That is, the variation in the diameter of the first bearing action member 22 with respect to the length thereof in the axial direction of the shaft 10 may be the same as the variation in the diameter of the second bearing action member 32 with respect to the length thereof in the axial direction of the shaft 10.

Accordingly, the forces exerted on the first and second bearing action members 22 and 32 by the first and second bearings 40 and 50 may be symmetric to each other. Vibration may be prevented from being increased due to the difference between the forces acting on the first and second impellers 20 and 30 when the first and second impellers 20 and 30 secured to the shaft 10 rotate.

Since the above-configured compressor omits runners (or collars or thrusts) required by a conventional multi-stage compressor and is configured such that one bearing simultaneously bears axial and radial loads of the shaft, the compressor according to this embodiment may achieve a simplified structure and a reduction in the number of components. Accordingly, the compressor according to this embodiment may be easy to manufacture.

Furthermore, the compressor according to this embodiment may have a smaller volume than a conventional compressor having the same compression ratio or may have a higher compression ratio than a conventional compressor with the same volume.

Moreover, the longitudinal length of the shaft may be reduced compared with that in the related art. Therefore, input of raw materials and processing time may be reduced. In addition, since the resonance frequency (or the critical frequency) of the shaft becomes higher with the reduction in the longitudinal length of the shaft, a separation margin between the rotational frequency (or the operation frequency) and the resonance frequency of the shaft may be additionally ensured. Therefore, the compressor according to this embodiment may be more advantageous in terms of safety.

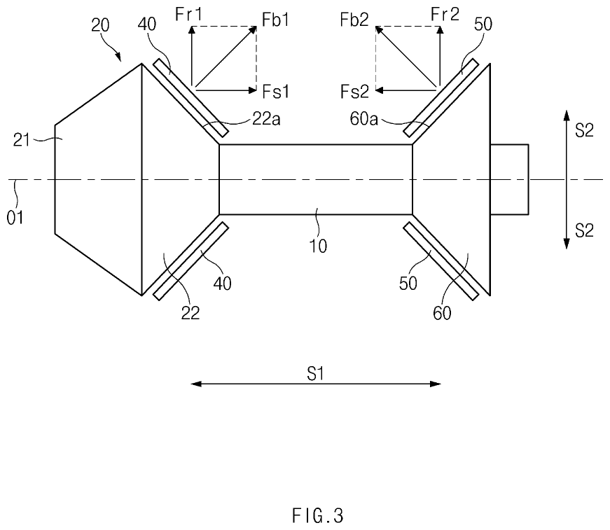

FIG. 3 is a view illustrating a part of a compressor according to another embodiment of the present disclosure.

FIG. 3 illustrates the compressor that includes the first impeller 20 but not the second impeller 30.

The compressor according to this embodiment differs from the compressor in the embodiment described with reference to FIGS. 1 and 2 in that the former includes a second bearing action member 60 rather than the second impeller 30.

The descriptions for FIGS. 1 and 2 may be identically applied to components in this embodiment that have the same reference numerals as those described with reference to FIGS. 1 and 2. The components in this embodiment that have the same reference numerals as those in FIGS. 1 and 2 may be substantially the same as the components described with reference to FIGS. 1 and 2.

The second bearing action member 60 may be secured to the opposite end of the shaft 10, which is opposite to the one end of the shaft 10 to which the first impeller 20 is secured.

Alternatively, the second bearing action member 60 may be integrated with the shaft 10.

The second bearing action member 60 may have a rotating body shape with a gradually decreasing diameter from the opposite end of the shaft 10 to the center thereof and may include a second action surface 60a with a tapered shape on which the second bearing 50 acts.

That is, the second bearing action member 60 may have a frusto-conical shape, which is obtained by cutting a cone with a plane parallel to the base of the cone, and may have a gradually decreasing diameter from one end of the second bearing action member 60 to an opposite end thereof.

The second bearing action member 60 may perform the function of the second bearing action member 32 of the second impeller 30 in the embodiment described with reference to FIGS. 1 and 2. The second bearing action member 60 may have the same shape as the second bearing action member 32 of the second impeller 30 in the embodiment described with reference to FIGS. 1 and 2. The description of the second bearing action member 32 of the second impeller 30 in the embodiment described with reference to FIGS. 1 and 2 may be applied to the second bearing action member 60.

In the above-configured compressor according to this embodiment, the shaft 10 and the first impeller 20 secured to the shaft 10 may be supported by the first and second bearings 40 and 50 in the axial directions S1 and the radial direction S2 of the shaft 10 as in the embodiment described with reference to FIGS. 1 and 2.

Since the above-configured compressor according to this embodiment omits runners (or collars or thrusts) required by a conventional compressor and is configured such that one bearing simultaneously bears axial and radial loads of the shaft, the compressor according to this embodiment may achieve a simplified structure and a reduction in the number of components. Accordingly, the compressor according to this embodiment may be easy to manufacture.

Furthermore, the compressor according to this embodiment may have a smaller volume than a conventional compressor having the same compression ratio or may have a higher compression ratio than a conventional compressor with the same volume.

Moreover, the longitudinal length of the shaft may be reduced compared with that in the related art. Therefore, input of raw materials and processing time may be reduced. In addition, since the resonance frequency (or the critical frequency) of the shaft becomes higher with the reduction in the longitudinal length of the shaft, a separation margin between the rotational frequency (or the operation frequency) and the resonance frequency of the shaft may be additionally ensured. Therefore, the compressor according to this embodiment may be more advantageous in terms of safety.

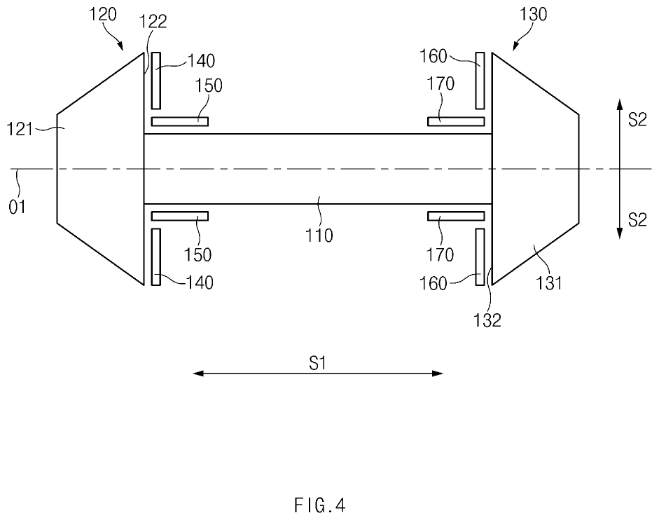

FIG. 4 is a view illustrating a part of a compressor according to yet another embodiment of the present disclosure.

The compressor according to this embodiment is characterized by using rear surfaces of impellers 120 and 130 as bearing action surfaces.

The compressor according to this embodiment includes a shaft 110, the first impeller 120, the second impeller 130, a first axial bearing 140, a first radial bearing 150, a second axial bearing 160, and a second radial bearing 170.

The first impeller 120 may be secured to one end of the shaft 110. The second impeller 130 may be secured to an opposite end of the shaft 110 that is opposite to the one end of the shaft 110 to which the first impeller 120 is secured.

The first impeller 120 may include a first blade part 121 for compressing fluid. The first impeller 120 may include a first action surface 122. The first action surface 122 may serve as an action surface on which the first axial bearing 140 acts, the first action surface 122 may be formed on back side of the first blade part 121.

The second impeller 130 may include a second blade part 131 for compressing the fluid. The second impeller 130 may include a second action surface 132. The second action surface 132 may serve as an action surface on which the second axial bearing 160 acts, the second action surface 132 may be formed on back side of the second blade part 131.

The first axial bearing 140 may act on the first action surface 122 and may support the first impeller 120 in one of axial directions S1 of the shaft 110.

The second axial bearing 160 may act on the second action surface 132 and may support the second impeller 130 in an opposite direction to the direction in which the first impeller 120 is supported by the first axial bearing 140. That is, the second axial bearing 160 may act on the second action surface 132 to support the second impeller 130 in the other axial directions S1 of the shaft 110.

The first radial bearing 150 and the second radial bearing 170 may be mounted on the one end and the opposite end of the shaft 110, respectively, and may support the shaft 110 in a radially inward direction (i.e., an opposite direction to a radial direction S2).

Since the above-configured compressor according to this embodiment omits runners (or collars or thrusts) required by a conventional multi-stage compressor, the compressor according to this embodiment may achieve a simplified structure and a reduction in the number of components. Accordingly, the compressor according to this embodiment may be easy to manufacture.

Furthermore, the compressor according to this embodiment may have a smaller volume than a conventional compressor having the same compression ratio or may have a higher compression ratio than a conventional compressor with the same volume.

Moreover, the longitudinal length of the shaft may be reduced compared with that in the related art. Therefore, input of raw materials and processing time may be reduced. In addition, since the resonance frequency (or the critical frequency) of the shaft becomes higher with the reduction in the longitudinal length of the shaft, a separation margin between the rotational frequency (or the operation frequency) and the resonance frequency of the shaft may be additionally ensured. Therefore, the compressor according to this embodiment may be more advantageous in terms of safety.

According to the embodiments of the present disclosure, at least the following effects are achieved.

First, the compressors according to the embodiments of the present disclosure are configured such that one bearing simultaneously bears the axial and radial loads of the shaft, whereby the structures of the compressors may be simplified, and the number of components may be reduced. For example, in the related art, two bearings bear axial and radial loads of a shaft. Whereas according to the present disclosure, one bearing may simultaneously bear the axial and radial loads of the shaft.

Second, the longitudinal length of the shaft may be reduced since the compressors according to the embodiments of the present disclosure do not include components, such as a runner, a collar, or a thrust, for axially supporting a shaft of a compressor in the related art. Accordingly, the critical frequency of the shaft may be raised. A separation margin between the operation frequency and the critical frequency of the shaft may also be additionally ensured, thereby further improving the safety of the compressors.

Effects of the present disclosure are not limited to the aforementioned effects. Any other effects not mentioned herein will be clearly understood from the accompanying claims by those having ordinary skill in the art to which the present disclosure pertains.

Hereinabove, although the present disclosure has been described with reference to embodiments and the accompanying drawings, the present disclosure is not limited thereto but may be variously modified and altered by those having ordinary skill in the art to which the present disclosure pertains without departing from the spirit and scope of the present disclosure claimed in the following claims.

What is claimed is:

1. A compressor comprising:
a shaft extending in axial directions thereof;
an impeller secured to one end of the shaft;
a first bearing action member provided at the one end of the shaft;
a second bearing action member provided at an opposite end of the shaft that is opposite to the one end of the shaft;
a first bearing configured to act on the first bearing action member and support the first bearing action member in one axial direction of the axial directions and in a radially inward direction of the shaft; and
a second bearing configured to act on the second bearing action member and support the second bearing action member in another axial direction of the axial directions, which is opposite to the one axial direction, and in the radially inward direction of the shaft.

2. The compressor of claim 1, wherein the first bearing action member has a rotating body shape with a gradually decreasing diameter from the one end of the shaft to a center of the shaft and includes a first action surface with a tapered shape on which the first bearing acts, and
wherein the second bearing action member has a rotating body shape with a gradually decreasing diameter from the opposite end of the shaft to the center of the shaft and includes a second action surface with a tapered shape on which the second bearing acts.

3. The compressor of claim 2, wherein the first bearing and the second bearing are tapered bearings configured to act on the first action surface and the second action surface, respectively.

4. The compressor of claim 1, wherein blades configured to compress fluid are provided at one end of the impeller with respect to the axial directions of the shaft, and
wherein the impeller is integrated with the first bearing action member at another end of the impeller that is opposite to the one end thereof.

5. The compressor of claim 4, wherein the impeller is referred to as a first impeller, and the blades provided on the first impeller are referred to as first blades,
wherein the compressor further comprises a second impeller secured to the opposite end of the shaft at which the second bearing action member is provided,
wherein second blades are provided at one end of the second impeller with respect to the axial directions of the shaft, and
wherein the second impeller is integrated with the second bearing action member at another end of the second impeller that is opposite to the one end thereof on which the second blades are provided.

6. The compressor of claim 1, wherein the first bearing and the second bearing are air-foil bearings.

7. A compressor comprising:
a shaft extending in axial directions thereof;
a first impeller secured to one end of the shaft and including, at one side thereof, first blades configured to guide a flow of fluid and, at an opposite side thereof, a first action surface with a tapered shape that becomes narrower toward a distal end;
a second impeller secured to an opposite end of the shaft that is opposite to the one end of the shaft to which the first impeller is secured, the second impeller including, at one side thereof, second blades configured to guide the flow of the fluid and, at an opposite side thereof, a second action surface with a tapered shape that becomes narrower toward a distal end; and
a first bearing and a second bearing configured to act on the first action surface and the second action surface, respectively,
wherein the first action surface and the second action surface face each other,
wherein the first bearing acts on the first action surface and supports the first impeller in one of the axial directions and in a radially inward direction of the shaft, and
wherein the second bearing acts on the second action surface and supports the second impeller in another axial direction, which is opposite to the one axial direction, and in the radially inward direction of the shaft.
